(19) United States
(12) Patent Application Publication
(10) Pub. No.: US 2008/0140705 A1
(43) Pub. Date: Jun. 12, 2008

(54) Method of Updating a Data Source from Transformed Data

(76) Inventor: Wenqiang Luo, Singapore (SG)

Correspondence Address: DICKSTEIN SHAPIRO LLP, 1825 EYE STREET NW, Washington, DC, 20006-5403, US

(21) Appl. No.: 10/573,834

(22) PCT Filed: Oct. 1, 2003
(86) PCT No.: PCT/SG03/00235

§ 371 Date: May 3, 2007

(51) Int. Cl. G06F 17/30

(52) U.S. Cl. 707/103 R; 707/E17.055

(57) ABSTRACT

The invention discloses an apparatus and a method for identifying nodes in a node-based data source, the apparatus being unique node identifiers, or series of unique node identifiers. The identifiers remain unchanged despite transformations of the data source. Any modification made to data derived from the transformations is also effected at the data source by means of the identifiers, the identifiers mapping the data in the transformed version of the data source to the data in the data source.

### FIELD OF THE INVENTION

The present invention relates to a data source updating method from transformed data.

### BACKGROUND OF INVENTION

There are currently several types of database structures of which the most common examples are the flat file database structure, the relational database structure and the hierarchical database structure.

Most database programmers are familiar with relational databases (e.g. MsSQL. Oracle), and fiat file databases (e.g. such as a text file with delimiters).

Data in text files or relational databases can be easily retrieved and updated. A line of data to be modified in a text file database is simply inserted, deleted or updated by direct user action in a text editor, from a simple script program or an advanced user interface program. If the data in a relational database is to be modified, this can be easily done by an insert, delete or update command in a query language such as SQL, which uses foreign keys and selection criteria to modify related tables.

An example of a hierarchical database structure is XML. In an XML database information is arranged in such a manner that data ‘drills down’ into branches of the database to retrieve the information required. This can be imagined as a tree with many levels of branches, and the data at the ends of the branches is classified according to the branches. In other words, XML source documents consist of data structured into ‘trees’.

XML data is usually used by, for example, XSL processors to produce an output result. Typically, a process begins with a source tree (or source document), and ends with a result tree (or result/transformed document, which may be any type of marked up document or simply a text document). Central to a data tree is the concept of nodes, which are data objects categorised as ‘branches’ of the tree. There are several node types, and these are known to the man skilled in the art. A simplified example of the types will be given here using the incomplete XML document shown below:

<?xml version=“1.0”?>
<?xml-stylesheet type=“infor/xsl” href=“link.xsl”?>
<Elmt1><Elmt2>Hello World</Elmt2></Elmt>
...
...

1. Root nodes: There can only be one root node because it represents the document itself. The root node of the XML document is the whole of the document.

2. Element nodes each represent an element and usually consist of a pair of the element tags. The root element in the example is <Elmt1></Elmt> The first child node of the example is another element, <Elmt2></Elmt2>. Sometimes, elements may not be defined by tag pairs but by a singular tag, such as <br> in HTML, which is simply a line break. Element nodes usually contain textual information.

3. Text nodes consist of character data, or text or strings, e.g. ‘Hello World’. Generally, text nodes are found encapsulated in element nodes.

4. Attribute nodes contains information on attributes, such as text styles etc which are scripted inside element tags.

5. Namespace nodes: Each element has a namespace node corresponding to its namespace prefix such as ‘xsl:’. Such nodes ensure that different elements with the same name, or different attributes with the same name and in the same element, can be distinguished. Namespace nodes are optional in XML documents and are not always be used.

6. Processing instruction nodes: contains processing instructions.

7. Comment nodes contains comments which are enclosed in <l--comments-->.

As a further example of the nodes in an XML document, the line of code:
<div> this is <b>bold</b>text </div>
   has five nodes, i.e.

| | |
|---|---|
| <div></div> | (pair of tags forming an element node) |
| this is | (a text node) |
| <b></b> | (format tags, also a node) |
| bold | (another text node) |
| text | (a third text node) |

A powerful feature of XML is that it provides a way of data sharing between different data systems, regardless of how the data is structured. The syntax structure of XML is similar to that of HTML, and the tags to identify the purpose of each piece of data, except that users define the tags themselves. This provides versatility in data classification and identification. As a result, XML imparts inter-system transportability to data.

An XML document's tags are interpreted, or the data therein selected and manipulated in a process called ‘transformation’ or ‘query’, depending on the type of XML processing script used. The output of the transformation may be data encoded in HTML syntax, or another XML document. The transformed XML document encodes selected data in tags defined by a recipient user so that the data may now be recognised by the recipient user's system. Therefore, XML does not have the conventional difficulty of data migration between databases with different table structures as with the relational database structure. Examples of such transformation/query technologies are XSLT (Extensible Stylesheet Language Transformation) or XQuery. The use of XQuery and XSLT is well known to a man skilled in the art.

The present limitation of XML is that there is no standard way by which modifications may be made to XML data through a script language, unlike in a relational database (e.g. SQL). XML updates have to be made through a text editor, or if the XML document is generated from a relational database, the document has to be regenerated after the information has been updated in the relational database.

Referring to the example below, if an XML document user wants to correct the title “Mr Chew's Life” to “Mr Chew's Other Life”, he has to look for the element node, <bio></bio>, containing the text node “Mr Chew's Life”, and then type over the book title in a text editor to change it (the book titles enclosed in the element tags are nodes in their own right, known as text notes).

Furthermore, if the modification of XML data is to be initiated on a transformed XML document, in such way that a corresponding update in the source document is effected as well, the updating action is then no longer just a straightforward replacement of data in through a text editor. At least two documents will be involved now, the transformed document and the original source document. Modifications to the data in the transformed document must be properly reflected in the correct source document(s).

The update action becomes particularly difficult if it involves deletion or insertion of element nodes such that the structure of the transformed XML document changes and the software engine for updating the source nodes relies on mirrored node positions between the source and transformed document to link them.

Current technologies, such as XPath, XPointer and XQuery are known technologies which define node positions in an XML document by the nodes' sequential order or by indexing the nodes. However such node positions are not persistent through editing actions.

A transformation/query performed on an XML document is analogous to an SQL query. However, re-arranging, inserting and deleting data in an XML source document through actions on a transformed document is presently impossible, especially if the XML structure is modified. Node indices, i.e. ordering of node positions, are not persistent when sibling elements are inserted, removed or re-arranged, making it impossible to maintain proper links between a source XML document and the transformed XML. document after multiple transformations or queries. Due to these limitations, it is difficult to manage an XML document like an SQL database.

US patent application 20030037303 proposes a mechanism for reversing XML transformations, which allows updating of data in an XML source document by actions through a user interface displaying the transformed document. Referring to FIG. 1, the US application proposes generating 16 an inverse-XSLT sheet 15 during a forward transformation by an XSLT style sheet 12 of an XML source document 11. When a viewer looks at the transformed document, which may be in XML or displayed as an HTML web page 13, and decides to correct or update a piece of data, he may do so on the display 13 itself. The updated display 14 will be inverse-transformed by the inverse-XSLT sheet 15 back into a source document 11. In other words, a new source document is created which replaces the original one. This mechanism can be used for a transformation process only where there is a one-to-one mapping between the original document and the transformed document, as the inverse transformation script has an expectation of how the structure of the document to be inverse-transformed should be like.

However, often transformations do not always consist of a single step process. In sophisticated XSLT and XQuery transformations, such as a multi-step transformation, the nodes in the resultant document may not have a one-to-one mapping mirroring the original nodes in the source document.

For example, an XML source document having one parent element node, two child element nodes, each of which contains one text node, such as that shown in FIG. 2, may be filtered in a transformation to extract only part of the data. The resultant extract is output in XML tags defined by another XML developer: one parent node, one child element node and one text node. If the viewer changes ‘text1’ in the transformed document when viewing it in a display, in order that the data is updated in the source document, the inverse-transformation must be able to identify which of the original nodes in the data branch ‘book1’ did ‘text1’ come from.

Furthermore, if instead of just processing one source document, several source documents are used to extract a resultant transformed document, an inverse XSLT transformation script of the kind proposed in US patent application 20030037303 has no way of determining from which of the original documents does a piece of data in the resultant document come and which source document therefore to update.

### SUMMARY OF THE INVENTION

The present invention aims to provide a data source structure and a method of operating upon that structure to assist in updating of a database by operation on data transformed or extracted from the data source.

An advantage of the described embodiment of the invention is that the method is not limited the kind of data transformation employed, the number of data sources used, the number of passes of data transformations or the types of presentation. The data transformation process can be complicated, as long as the source node identifiers are passed on after each transformation.

According to the invention in a first aspect, a method of identifying data in a node-based data source is provided, comprising the steps of annotating each node with a unique identifier.

According to the invention in a second aspect, a method of modifying a node-based data source is provided, comprising the steps of associating selected nodes in the data source with identifiers, identifying a node to be modified by reference to its identifier, and modifying the node data.

According to the invention in a third aspect, a data source structured to operate as a node-based data source is provided, wherein at least one node is associated with a unique identifier.

According to the invention in a fourth aspect, a method of annotating a transformed version of a data source is provided, comprising the steps of copying identifiers in the nodes in a data source to corresponding nodes in the transformed version of the data source.

According to the invention in a fifth aspect, an identifier which is capable of uniquely identifying a node in the data source and also a corresponding node in a transformed version of the data source is provided, whereby the node in the data source is mapped to the corresponding node in the transformed version of the data source.

According to the invention in a sixth aspect, a data transformation engine is provided, comprising means of copying identifiers of nodes in the data source and inserting the identifiers into the nodes of the transformed version of the data source, whereby the nodes in the transformed version of the source data are mapped to their corresponding nodes in the source data.

According to the invention in a seventh aspect, an industrial standard of node-based document modification is provided.

According to the invention in an eighth aspect, an industrial standard of identification of nodes in a node-based document is provided.

According to the invention in a ninth aspect, an industrial standard of node-based data transformation is provided.

In general terms, the described embodiments of the invention provide a mechanism that allows a node-based data source, such as an XML document, to be updated from transformed data.

The mechanism comprises ways of preserving a link between a source document(s) and a transformed document, using annotations (or universal identifiers) so that the source of a piece of transformed data is always known. The source location of each piece of data is obtained by the identifiers, even after multiple-passes of sophisticated transformation, and even when the resultant document is a combination of multiple source documents. In contrast to US patent application 20030037303, in order for an update action to be performed, there is no need to generate an inverse transformation script every time the source document is modified or transformed. Furthermore, the mechanism allows update requests to be sent directly to the original data source by means of the identifiers, instead of through an inverse script.

The embodiments described hereafter illustrate how node annotation allows data manipulation in an XML document, such that command procedures and routines may be designed to work on the documents in the same way as scripts are being used to update other types of database such as relational tables or a flat-file database. This imparts data interaction possibilities to XML engines, parsers, editing agents and displays, making XML a more user-friendly form of database structure.

### BRIEF DESCRIPTION OF THE FIGURES

Embodiments of the invention will now described, by way of example, with reference to the accompanying drawings, in which:

FIG. 1 is a flowchart illustrating the process of the prior art found in US application 20030037303.

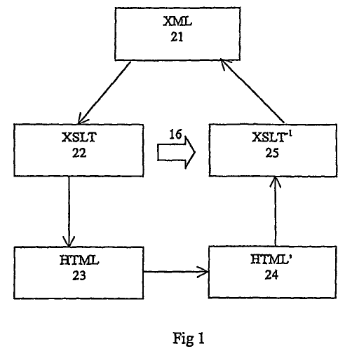

FIG. 2 shows a prior art example of a transformation based on two source XML documents.

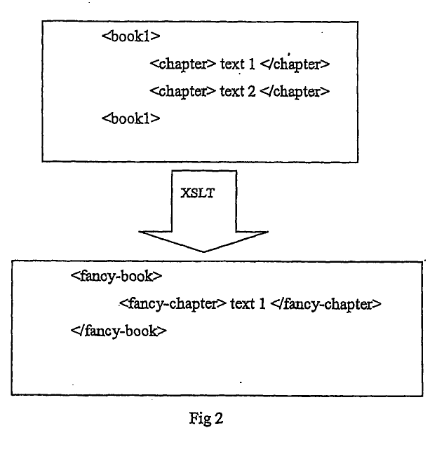

FIG. 3 is a flowchart illustrating a method of XML source document updating according to an embodiment of the invention.

FIG. 4 is a flowchart further illustrating the method of XML source document updating of FIG. 3.

FIG. 5 illustrates how the position of a new node may be decided on in an insertion or node creation action, giving an further example to the insertion method disclosed in FIG. 4.

FIG. 6 illustrates how several source documents may be transformed but yet retained a traceable link to the original source documents according to the methods of FIGS. 3, 4 and 5.

FIG. 7 illustrates a method of modifying a transformation script by using the method disclosed in FIGS. 3 and 4.

### DETAILED DESCRIPTION OF THE PREFERRED EMBODIMENT

### Interactions Between Source Document Agent, Transformation Agent, Editing Agent and Viewer.

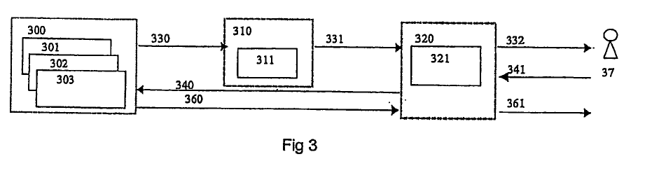

FIG. 3 is a flowchart showing an embodiment of the method of the invention. A source document agent 300 is provided which manages one or more source XML document(s) 301, 302, 303. The XML documents 301, 302, 303, each has a plurality of nodes associated with data.

A transformation agent 310, on being triggered, runs one or more transformation scripts 311, which may be scripted in XSLT, XQuery or any other XML transformation language. A transformation script 311 determines how an XML document is transformed into another format. The transformation may include data selection and extraction, or combination of data from several XML documents, in ways analogous to queries performed on the tables of a relational database.

An editing agent 320 receives transformed documents 321 produced by the transformation agent 310, and displays them (e.g. in a browser if the transformed documents are HTML documents).

When a transformation of the XML document(s) 301, 302, 303 is triggered, the source document agent 300 firstly annotates each node, i.e. the element tags, the text nodes and so on, in the source XML document(s) with a unique identifier. The transformation agent 310 then receives (at 330) the annotated XML document(s) 301, 302, 303 to perform the transformation/query according to the instructions in the transformation/query script 311, producing a transformed document having data selected from the source document(s) 301, 302, 303. Whether the transformed document is of a different document format, such as HTML, or is also an XML document, the tags defining the elements nodes in the transformed document can be completely different from those in the original XML source documents. Nevertheless, when the transformation agent 310 encloses the extracted text information in tag pairs defined for the transformed document 321, the transformation agent 310 also transfers into the tag pairs the same identifiers which identified the data in the source nodes in the source documents 301, 302, 303. Similarly, the text is also extracted and produced in the transformed document as text nodes, which are also annotated with the same identifiers of their respective source nodes.

The transformed document 321 is then sent (at 331) to the editing agent 320, where the transformed document 321 is displayed (at 332) to a viewer 37 of the document. The editing agent 320 may be an user interface, or is embedded in an user interface, which allows the viewer 37 to interact with the displayed data, such as to perform data updating (data ‘updating’ shall hereafter in this description understood to be inclusive of data replacement, insertion, deletion, copying and so on).

Any modification on the displayed data by the viewer may now be mirrored in the source XML document(s) 301, 302, 303 by means of the identifiers.

An update action (at 341) initiated by the viewer causes the editing agent to send an update request (at 340) directly to the source document agent 300, which performs updating on the source XML document(s) 301, 302, 303. The update request (at 340) is sent along with the identifiers of the nodes on which the viewer 37 has acted.

The source document agent 300, on receiving the update request, has to decide if the update request is allowable, for example, by constraints of security or the schema of the source document, or by applying rules implemented by the programmer. If the source document agent 300 accepts the request, the source document agent 300 uses the node identifiers and data values sent over with the request to locate and update the correct source nodes in the source document(s) 301, 302, 303, be it text nodes, attribute nodes or element nodes formed by tags or tag pairs.

After the source document agent 300 has completed the updating, the updated XML source documents 301, 302, 303 are sent again 330 to the transformation agent 310 to have the same transformation script 311 re-run on the updated source document(s) 301, 302, 303. The newly transformed document 321 is then sent to the edit agent 320 so that the display is refreshed, reflecting the data update. The process repeats as long as the viewer keeps updating the data.

Optionally, the re-transformation on the updated source document(s) 301, 302, 303 may be performed partially, by just re-transforming updated or new nodes. Before re-transformation, nodes which already have been annotated are not annotated again. This ensures that the identifiers persist throughout many transformations. However, new nodes which are inserted into the source documents for the first time are annotated with unique identifiers before re-transformation.

If the update request (at 340) sent to the document agent 300 is not deemed acceptable by the source document agent 300, the source document agent 300 sends a rejection response (at 360) to the editing agent 320. The display will then show a rejection message (at 361) to the viewer 37, preferably also showing the reason for the rejection of the update request.

As mentioned above, the transformation of the source XML document may, instead of a single step transformation, comprises multiple transformations. These may be implemented by executing a number of XSLT and/or XQuery scripts 311 continually, i.e. each XML document transformed by one transformation script 311 is immediately subjected to a further transformation by another transformation script 311, until the final transformed document 321 is sent to the editing agent 320.

Similar to the annotation mechanism described above, the first transformation in a multiple-transformation step triggers the source document agent 300 to annotate the source document(s) 301, 302, 303 with unique node identifiers, which will be inherited by the first transformed document. In transformations subsequent to the first one, identifiers of the nodes in each earlier transform document are in turn inherited by the nodes in the next transformed document. Thus, the nodes in the final multi-transformed document 321 are traceable to the source nodes in the original XML source document(s) 301, 302, 303.

The source document agent 300, therefore, on receiving update requests from the editing agent 320, can carry out updating of the correct nodes in the source document(s) 301, 302, 303, even in response to user action on an extensively multi-transformed document. In other words, the links between the nodes of the source XML document(s) 301, 302, 303 and those of the transformed document 321 are not lost, even if the transformed document 321 is the result of many transformation passes and may have a totally different structure from that of the original source document(s) 301 302 303. Furthermore, even if there are more than one source document, the nodes can still maintain persistent links to the different source documents 301, 302, 303, as the identifiers are unique to each and every source document and node.

### Further Example on the Effect of Updating Actions on XML Document Nodes

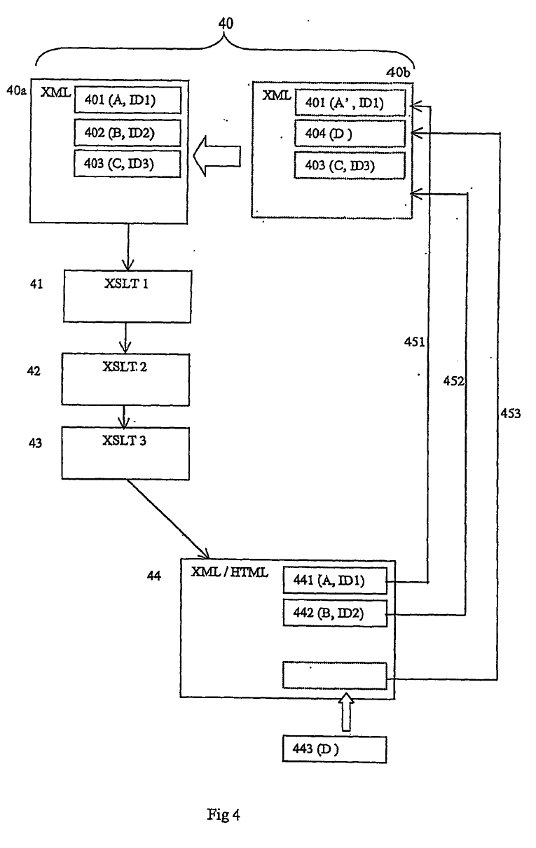

FIG. 4 is another flowchart, which further illustrates the above-described mechanism of FIG. 3, and also shows how, in addition to modification of existing nodes, new nodes can be added. The example of FIG. 4 uses only text nodes for the sake of simplicity, but it is equivalently representative of other processable XML node types, such as element nodes which are formed by singular tags or tag pairs containing text nodes. Note that in FIG. 4, an original unmodified source document 40a and the same source document, but modified 40b, are shown, and both are also represented by the label ‘40’ in the figure.

A source XML document 40a has three pieces of data as text nodes, A, B and C. When a transformation is triggered, the nodes are firstly annotated with node identifiers, respectively ID1, ID2 and ID3. The nodes are then subjected to multiple transformations 41, 42, 43 defined in XSLT scripts (alternatively, XQuery or other kind of transformation scripts may be used, or the steps 41, 42, 43 may each use a different type of transformation script).

The transformed document 44 may be another XML document or an HTML document, which is displayed to a viewer having read/write access. The transformations/queries 41, 42, 43 select and extract into the transformed document 44 only the data A and B, which become text nodes 441, 442 in the transformed document. The node 403 of data C having an identifier ‘ID3’ is not selected by the transformation script because, for example, of selection criteria. The identifier ‘ID1’ for the first text node 401 which is data A, is also copied to the transformed document 44 as the identifier of the corresponding text node 441 containing data A. Similarly ‘ID2’ is copied to the transformed document 44 as the identifier of text node 442 of data B.

A viewer (human operator) then modifies node 441 data A to A′, deletes node 442 data B at and inserts new data D (which creates a new un-annotated node 443) in the transformed document 44.

When an update command 451 is sent to the source document agent, the identifier ‘ID1’ of the text node 441, now A′, is also sent to the source document agent with the new data A′, so that the source document agent can update the correct node 401 having the identifier ‘ID1’ to be A′ instead of A.

Acting on the transformed document, the user deletes the text node 442 of data B, identified by ‘ID2’. When the editing agent sends the deletion request 452 to the source document agent, the source document agent deletes the corresponding source node 402 in the source document 40 identified by the identifier ‘ID2’, effectively removing data B from the source document 40b.

As the nodes are identified by the identifiers, the deletion of the nodes 402, 442 containing B, identified by ‘ID2’, though changing the XML tree structures in the transformed document 44 and the source document 40, does not change the identifier ‘ID1’ of the node of A′. Any source node in the source document is, therefore, still ‘linked’ to the corresponding node in the transformed document by its identifier. In this manner, the updating and modification of data in the source document is effective, independent of inverse transformation scripts, can be effected by actions performed on the transformed document and is regardless of any difference between the structures of the source and transformed document or any changes in the structures.

It is important to note that if the text node inside an element node is deleted, the element node, which is usually formed by an element tag pair, and the element node identifiers remain in the XML document, albeit enclosing no text node. However, when an element node (i.e. the tags defining the element node) is deleted, the entire element node, its identifiers, any text nodes inside the element node, and any child node(s) in the element node are all removed from the XML document, and the XML document structure is changed.

When the data D 443 is sent to the source document agent for insertion, the insertion command cannot be sent with an identifier since D is newly created/inserted in the transformed document and does not have an identifier. Different strategies can be employed to decide where this new text node is placed in the source document 40.

As an illustration of the many possible insertion strategies, the editing agent may be programmed to reference, in the transformed document 44, the sibling or neighbouring node next to which the new node is to be created. For example, the text node 441 of data A having an identifier ‘ID1’ may be referenced (the node 442 containing B having identifier ‘ID2’ is not used as it has been deleted earlier). The editing agent then sends a node insertion/creation request to the source document agent along with the identifier of the sibling node, ‘ID1’.

When the update command is sent to the source document agent, the source document agent looks for a node having the identifier ‘ID1’ in the source document 40 to position/insert the new source node 404 with reference to node ‘ID1’. Specifically, whether creating the new node means creating it in a position above or below the reference node 401 in source XML document is left to the developer designing the insertion mechanism to specify. The example of the strategy given here for text nodes is applicable for other processable nodes, such as element nodes.

Another insertion mechanism strategy is one in which the parent node of the new node to be inserted is identified, instead of the sibling node. The source document agent will simply insert a new child node under the corresponding parent node in the source document, next to all the existing child nodes.

Referring to Table 1 as an example, assuming that the XML document is a transformed document, if a viewer wants to add a new book ‘The Life Of Claude’ in the biography section, the editing agent must allow the viewer to insert ‘The Life Of Claude’ into the transformed document (by generating the suitable element tags <bio></bio> to form an element node enclosing the title which is a text node). When sending the update request, the editing agent sends, inter alia, the identifier of the parent node <blography></biography> (the node identifiers are not indicated in Diagram 2, but it is assumed here that the nodes are all annotated for this illustration) to the source document agent, instead of the identifiers any of the sibling element nodes. The source document agent is, in this case, programmed to create a new child element node under the identified parent node, and to insert the title as a text node into the new element node.

The purpose of these examples is not to specify all the updating mechanisms that can be devised, but to show that node identifiers can be used to facilitate the design of such mechanisms. Naturally, the node insertion/creation command sent to the source document agent must specify enough detail in order to let the source document agent knows exactly how and where to act, but other mechanisms will be apparent to one skilled in the art once aware of this disclosure.

Referring now back to FIG. 4, the modified source XML document 40b therefore has the node containing A′ with the identifier ‘ID1’, the new node containing D without an identifier and the node containing C with the identifier ‘ID3’ which was not extracted to the transformed document 44 and has never been modified.

The updated XML source document 40b is then subjected to the same transformations 41, 42, 43 before being displayed 44 with the updated data. Just before re-transformation, only the new node 404 will be subjected to annotation. Existing nodes, which already have identifiers, are not re-annotated. This ensures persistency in the identifiers.

The update/re-transformation cycle continues until the viewer is satisfied with the modifications.

There is a possibility that a newly added node may not be reflected in the updated display of showing the re-transformed document. This may be due to reasons such as the selection criteria of the transformation/query scripts 41, 42, 43. For example, if the transformation/query scripts 41, 42, 43 include a criterion of selecting only text nodes having a string starting with letter ‘s’, and if the text in the new node 404 starts with the letter ‘t’, (or if the updating of an existing text node changes the text therein to one which starts with the letter ‘t’) then the new data would not be selected during re-transformation, and will not be sent to the editing agent. In such situation, in order to assure the viewer that the node insertion/updating is successful, several strategies may be employed. For example, the editing agent may be programmed to be alerted whenever a new node has been inserted or an existing node is updated, and thus to ‘look out’ for the piece of new data when the display is refreshed. If the new information does not appear after re-transformation, the editing agent may send a confirmation request to the source document agent, which may then invoke a pop-up message to the viewer confirming successful insertion/updating of the new data. Alternatively, the selection criteria of the transformation script 41, 42, 43 may be by-passed for the inserted or updated node, such that the display 44 will show the new data regardless of the selection criteria in the transformation/query scripts 41, 42, 43. A simpler alternative is to program the editing agent to always warn the viewer that a update may not be reflected in the display due to transformation script selection criteria, and that the viewer ought to take other measures to check that the data is inserted, such as running a ‘select all’ script.

If the transformed document is a combination of several source documents, the insertion of nodes will be even more complicated. For example, if the sibling nodes in the transformed document all come from different source documents, rules will have to be programmed into the system such that the editing agent knows which of those nodes (the neighbouring node on the left, right, top or bottom in the XML document) is to be considered a sibling node, and so send the correct identifier as a reference to the source document agent, so that the correct source document may be updated with the new data. Other selection criteria for the sibling node may be used, for example, looking for a node containing some specific text or a number within a certain value range and so on.

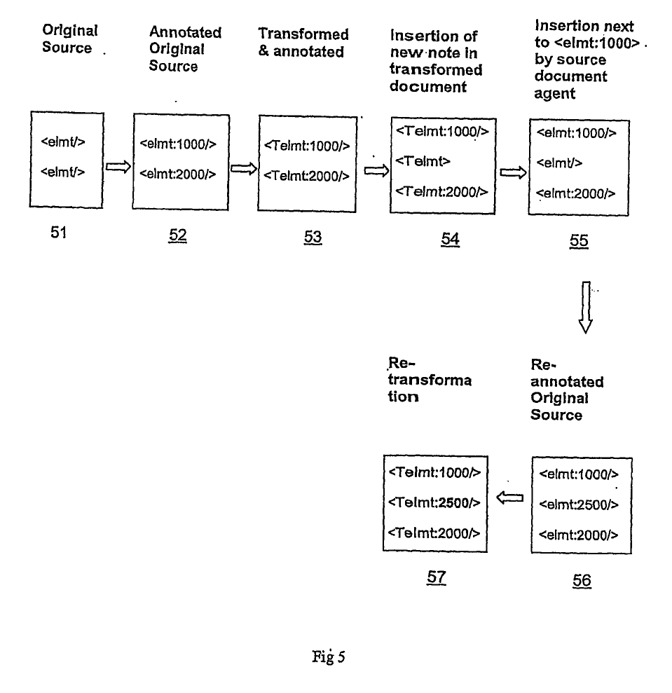

A simplified example of how the mechanism of an insertion action may be done by referencing or ‘anchoring’ to a sibling node is shown in FIG. 5.

FIG. 5 shows two element nodes defined by <elmt> tags in a source document 51. Closing tags are not shown for the sake of simplicity. On transformation, the <elmt> tags are annotated with identifiers 1000 and 2000 52, the information in the <elmt> tags are then output into the transformed document 53, the source elements re-tagged in <Telmt> tags. In the transformed document, a new <Telmt> tag is created in between the existing <Telmt> elements 54, and the creation is reflected in the source document by a corresponding creation of an new <elmt> between <elmt:1000><elmt:2000> 55. The location in the source document in which the new node is created can be obtained by referencing the anchor node (e.g. the node having identifier 1:1000) when sending an update request to the source document agent, or may be programmed into the rules of a user interface to always refer to any other particular sibling node. Before re-transformation, the new <elmt> tag is annotated with identifier 2500 56. On re-transformation, a new node, <Telmt: 2500> is created in the transformed document, with the identifier 2500.

Optionally, the developer may set various constraints on the modifications that can be performed by the source document agent, such as user's access (read/write) rights to an entire source document or even to particular node(s) in the document. Other constraints may come from business logic or XML schema of the source document and so on.

Generally, in order that the transformed documents are annotated with the correct identifiers in the correct nodes, the transformation agents or query agents need to be able to transfer the source node identifiers to the nodes in the transformed documents. Any node in the transformed document which contains editable information from the source document (such as text, elements and attributes) should contain the same identifier from its corresponding source node.

### Properties of Identifiers

As illustrated in the above examples, the underlying mechanism of the embodiments is in the annotation of the nodes in the XML source document(s) 301, 302, 303 with unique identifiers. The unique source node identifiers can be numerals, text strings or both, or any other data types (such as binary format or binary representation). The node identifiers must be unique for all the nodes in the XML documents that are to be used together in a transformation (preferably even globally unique to all existing XML documents). A node's identifier preferably persists throughout the existence of the node, and even when updating actions performed on neighbouring nodes changes the XML document structure.

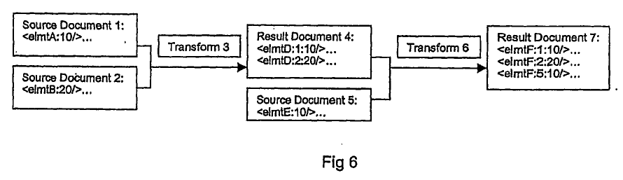

FIG. 6 illustrates how an XML document may be transformed several times and yet retains links to the source document by node identifiers. The final Document 7, despite have been though two transformations 3, 6 and is a combination of Documents 1, 2, 5, has annotations traceable back to the original source Documents 1, 2, 5. As shown, the node <elmtF:1:10/> in Document 7 shows that it came from document 4, element node <elmtD:1:10/> which in turn came from Document 1, element node <elmtA:10/> (the highlighted fonts represent the identifiers).

Similarly, the node <elmf:5:10/> is traceable to node <elmtE:10/> of Document 5, based on the identifier ‘5:10’. The name of the elements tags after each transformation does not matter as long as the identifiers persist through transformations.

Specifically, identifiers are persistent through the following updating actions:
i. when another node which is above, below or in the same level in the node hierarchy is modified, inserted or deleted;
ii. when the order of the sibling nodes, nodes in the same branch and at the same hierarchy level, is re-arranged.
iii. when an attribute, e.g. formatting attributes, of an element is modified, created or deleted from the element.

### Further Preferable Features

Preferably, node identifiers are not recycled. In other words, a newly added node should not re-use any identifiers that have been used by deleted nodes.

Furthermore, nodes in the transformed document should preferably bear only the unique identifiers of the source nodes and should not have their own unique node identifiers generated. That is, a document should not contain unique identifiers of another source document and different unique identifiers of itself at the same time, or the system may be confused or rendered unnecessarily complicated.

Preferably, the identifier syntax is implemented in such a way that the conventional XML data model or info set model is not changed by the annotations, even though each node would now have an associated identifier. In other words, the present mechanisms of XML parsing/processing is not hampered or disturbed by the annotations, so that standard XML parsers may work on annotated XML documents without needing to be modified.

The source document agent preferably has rollback functions built into its design, to enable the update actions on the source documents to be undone when requested. The strategies for implementing rollback functions are well known to the man skilled in the art and will not be discussed further.

In one variation, the source document 40a, after updating becomes a separate source document 40b from the original source document 40a, the original source document 40a may then be archived.

In a further variation, compression mechanisms may be used to minimise the amount of data communication after re-transformations, for example, using XDiff to find the differences between the XML documents before and after the updates and send only the changed parts to the editing agent for refreshing the display.

As described earlier, due to the passing-on (or inheritance) of the identifiers between transformed documents during a multi-transformation step, the nodes in a final transformed document have the same identifiers as the source nodes. However, in an alternative embodiment, the system may be designed in such a way that transformed documents intermediate in the multi-transformation step have identifiers different from other intermediate transformed documents. This will require, however, a ‘middle-man’ database mapping/tracing the identifiers from each transformation to another, in order to link the nodes between the each intermediate transformed document, the final transformed document and the source document. The design can be used to facility debugging by identifying at which of the several transformation scripts has a problem been caused, when there is any. This also can be used to provide a proxy or firewall interface to protect the nodes in the source documents from direct access for hackers which may use the annotations to trace the data in the source document.

The mechanism described in the embodiments so far relies mainly on three major modules or components: the source document agent, the transformation or query agent, and the editing agent. These modules can be implemented in a distributed intranet or internet environment.

Furthermore, they can be arranged locally or remotely in a distributed environment. Where implemented remotely, the source document agent and the transformation (or query) agent are grouped together in a source document management system, in a ‘fat-client’ arrangement. The source document management system is responsible for storing the source documents and transformation scripts, generating the globally unique source node identifiers, performing transformations or queries and updating the source documents upon requests from the editing agent. The source document management system functions as a server in the distributed environment, having a role which is analogous to a conventional web server combined with the relational database management system. In such a remote network system, the editing agent, which resides on the client side, has a role similar to a conventional web browser but has further functions for data editing interactions. As the client does not need to support complicated transformations such as source document updating and management, this arrangement is advantageous for ‘thin-client’ implementations, such as Kiosks, PDAs and mobile phones. As variations, the client and server can both exist as different processes in a same machine, or in two different machines across an Intranet or the Internet. All that is needed is an implementation of a communication protocol to transmit the transformed documents and the various action requests and feedback between the source management, transformation and editing agents.

Where implemented in a local system, the source document agent, the transform or query agent and the editing agent all run within a same process on the same machine. This may be the implementation choice when the source documents and transform scripts are meant to be available in one system, or when they can be completely or partially downloaded from a server onto a local machine for processing. Therefore, the source document can be edited and updated completely on the client-side without any intermittent server interaction and communication. In the case where the XML documents and transformation scripts are downloaded into the client side for complete processing, upon completion of the updating or other processing, the client resubmits the source documents to the server to completely replace the original source documents. The server's role is therefore simplified to data fetching and to indicate success or failure of the substitution of the source documents, while the client performs all the processing. The communication between the source agents and the editing agent, since now completely within the client machine, can be simplified to using function calls instead of complicated communication protocols.

A further implementation is one which has multi-user concurrent access. This mean that the source documents are not required to be locked during editing, i.e. a source document can be shared by any number of people, or be used by one person working on multiple editing applications. This is possible because user editing actions can be broken down into a sequence of select/insert/delete/update operations on individual node(s) in the source documents, in a way which is very similar to those of SQL statements in a relational database.

### Stored Procedures in the Source Document Agent Programmable

At times, there might be a need to carry out a sequence of updating actions which can be packaged into a set of stored procedures in the source document agent (similar to stored procedures in SQL or macros in MSWord). It is left to the developer implementing this invention to design the stored procedure language and syntax. An example of the syntax of an action invoking a stored procedure in the source document agent is given below:
invoke foo(param1, param2 1:1002, 2:2003) on document “abc.xml” using document 1 from “def.xml”, 2 from “ghi.xml”

The editing agent may invoke stored procedures by passing parameters. The parameters may contain literal value and the relevant unique source node identifier.

Generally, the well-known CGI (Common Gateway Interface) that supports server-side scripting can be utilised to build the request/response mechanism. There is no limitation on which language or facility is to be used to implement the stored procedures. Existing web related languages like Java, ASP, C#, PHP, or any future action language defined specifically for XML can be used.

### Identifiers in Source Documents

The unique node identifiers will now be described in further detail.

In a certain embodiment, an identifier may be made up of three parts: an Originator ID, a Document ID and a Node ID. The composition of the identifier may be varied depending on the preferences of the system programmer, but the identifier should generally impart sufficient uniqueness to the nodes.

The Originator ID identifies the person or originator who created or owns the XML document. In a business environment, the Originator ID may be the domain name or primary IP address of the company or organisation. For large enterprises, the Originator ID may be composed of a hierarchy of IDs, e.g. ‘Domain ID+Sub-domain ID+Group ID+ . . . +Server ID+User ID’ and so on. In an end-user environment, where not every user has a domain name, the Originator ID may even be the originator's email address.

Preferably, the Document ID is a serial number.

Optionally, a separate database may be created to map Document IDs to the file paths or URLs of source documents, by which the source document agent may locate the source document for data updating.

As documents are often moved around in a file system and ported from system to system, it is also preferable that the Document ID is designed in a way that it is persistent despite file transfers between different system, i.e. the IDs are not descriptively tied to the system in which the documents reside.

The last component of the identifier is the Node ID, which is typically a number that is generated incrementally.

The three IDs combined to give a unique identifier. However, depending on the system designer's preference or the resources available to generate unique identifiers, other combinations of identifying components may be used.

An example of how the identifier syntax is extended to standard XML tags and data, in order to allow the unique source node ID to be persistent in source documents, will now be given.

As a first example, the straightforward way is to insert into each node the entire identifier. However, depending on the way an identifier is generated, the identifier may be a very long string. In such cases, since the ‘Domain ID+Document ID’ portion of the identifier is identical for all the nodes in each XML document, instead of repetitively inserting a long identifier in each individual node of the same XML document, the ‘Domain ID+Document ID’ part may be declared in a header of the XML document, while only the Node IDs are inserted into the nodes.

The syntax of the header may be in standard XML declaration syntax. For example, if the Originator ID is ‘peter@abc.com’, and the Document ID is ‘doc123456’, instead of appending both IDs to each and every node in the document, they may be declared in a header in the document:

| | |
|---|---|
| Combined ID | <?UniqueDocumentID peter@abc.com/doc123456 ?> |
| declaration: | |
| Normal XML | <tags> ...XML tags and data... </tags> |
| following: | |

Each node in the document is then annotated only with Node IDs, which are appended to the XML elements, attributes or processing instructions. The following show nodes in an XML document having Node IDs (in bold) placed after colons:

| | |
|---|---|
| Parent node: | <namespace:elmt:11001 |
| Attribute node 1: | attr:11003= “an attribute with Node ID”> |
| Child node 2: | <elmt:11002/> |
| Child node 3: | <?pi:11008 a processing instruction with node |
| | identifier ?> |
| Child node 4: | <!--&11006; a comment with node identifier --> |
| Child node 5: | &11005; a text node with node identifier. |
| Closing tag: | </namespace:elmt> |

The XML standard has specified that XML names cannot begin with numerals, therefore the syntax in the above-shown parent node and child nodes (1 and 2) will not confuse the XML parsers. However, in the above example, an escape character, such as an ‘&’ sign is used to indicate an ID for a text. Using this symbol for XML data and comments (child nodes 3 and 4), the annotated document no longer has valid XML syntax. An XML parser to be used on the annotations might have to be modified to recognise and parse the extended syntax.

In an alternative form, the annotation performed by mapping node positions in an XML instruction tags. The XML codes below shows Node IDs in an instruction tag, with a list of Node IDs mapped to child node positions:

| | |
|---|---|
| Node 1: | <?UniqueNodeMapping 2=11001 3=11003 |
| | 4=11002 5=11008 6=11006 |
| | 7=11005 ?> |
| Node 2 mapped to 11001: | <namespace:elmt |
| Node 3 mapped to 11003: | attr = “an attribute with node |
| | identifier”> |
| Node 4 mapped to 11002: | <elmt/> |
| Node 5 mapped to 11008: | <?pi a processing instruction with a node |
| | identifier ?> |
| Node 6 mapped to 11006: | <!-- a comment with a node identifier --> |
| Node 7 mapped to 11005: | a text with a node identifier. |
| | </namespace:elmt> |

The first node shown above lists the Node IDs for each of the child nodes in the document. However, if a node is inserted or deleted, the entire mapping has to be regenerated. An advantage of this type of ‘header mapping’ is that the entire annotated source document remains a valid XML document despite the insertion of the identifiers in the ‘header’ using the syntax of an XML processing instruction. Therefore, existing XML parser and other processors can be used on the source documents without modification. However, such processors should only be granted read-only access, but not write access to the source documents (for example by making the file ‘read-only’), as they might remove the first node containing the important node-identifier mapping information.

In the two types of annotation steps described above, the former scheme requires the XML parser/application to understand the annotations, so there is no risk of external applications messing up the identifiers inadvertently in some operations. As the annotation is localised, i.e. inserted directly into each node, non-DOM base XML parsers, like SAX, can be implemented which allow parts of the XML tags to be skipped during parsing. In the latter scheme, the syntax of an XML tag that is normally used to contain processing instructions is used to contain the header mapping. In this case, existing XML parsers and processors can be used (for read-only access) without modification.

### Identifiers in Transformed Documents

Variations of the annotation in transformed documents are similar to those described above in source documents.

For a transformed document which is a combination of several source documents, the example below shows how the several Document IDs in the transformed document may be declared using prefixes, in a similar way to how namespaces are declared and referred to in standard XML syntax:

<?UniqueSourceDocumentID peter@abc.com/doc123456 as 1 ?>
<?UniqueSourceDocumentID tom@abc.com/doc/1111111 as 2 ?>

The declaration shows the IDs of two source documents, which were used to form a transformed document, having alias of ‘1’ and ‘2’. During the annotation step before transformation, the source document agent assigns one of the two aliases, ‘1’ or ‘2’, to the nodes of each respective document. Each node in the transformed document may therefore contain an alias instead of an entire Source ID, linking each node in the transformed document correctly to one of the source documents.

As shown above, the name of the processing instruction is preferably UniqueSourceDocumentID instead of UniqueDocumentID, to emphasise to the programmer that the identifiers indicated in the tag is of source document(s).

An example of identifier syntax that annotate each individual node is given below:

Example of transformed document:

| | |
|---|---|
| XHTML node transformed from document 1: | <div:1:11001 |
| Attribute that is not bind to any source node: | attr =”...”> |
| XHTML node transformed from document 2: | <img:2:11002 /> |
| XHTML text node extracted from document 1: | &1:11005; text node |
| | </div> |

In an annotation scheme corresponding to the one given earlier for source document annotation, an annotated ‘header tag’, such as an XML processing instructional node, may be used to map child nodes, by declaring a mapping between nodes and the Node IDs:

| | |
|---|---|
| XML processing instruction node: | <?UniqueSourceNodeMapping |
| | 2=1:11001 4=2:11002 |
| | 5=1:11005 ?> |
| Transformed node 2 from document 1: | <div |
| Transformed node 3 without binding: | attr =”...”> |
| Transformed node 4 from document 2: | <img/> |
| Transformed text node 5 from | text node |
| document 2: | </div> |

Preferably, the method is implemented in such a way that there is no need to amend the structure of the transformation script (e.g. XSLT or XQuery) despite the identifiers. The transformation/query agent (or engine) is simply modified to perform extra steps to transfer the source node identifiers during a transformation/query into the transformed document.

In general, there are two main types of transformation actions which must be accompanied by a transfer of identifiers:
1. Steps or processes that require establishing a current node. For example, if the transformation process includes a loop operation or an application of a template, the transformation engine must able to identify the (reference) node from which the operation begun, i.e. the innermost loop in a nested loop, so that reference may be made to that node when looping or applying template.
2. Steps that output data from source nodes into the transformed document. Such data may be subjected to modification by the viewer, and the nodes containing the data must therefore be traceable to the source document.

### Editing Agent

The updating mechanism behind the editing agent 220 the will now be elaborated upon.

An updating request is sent by the editing agent via a communication standard to the source document agent. It is left to the developer implementing the method to define the communication standard and to choose the communication protocol. For example, the communication might be a SOAP/XML protocol that is built on TCP/IP, a remote procedure call or normal function call if the source document agent and editing agent both reside in the same system.

Generally, an update request should contain three specific pieces of information:
1. The action to perform, e.g. to insert a node, delete a node, or update a node;
2. The node to modify: i.e. using the unique source node identifier of the node to be modified;
3. The value to use: if the action is an update action, then the new value has to be supplied.

Editing interfaces (i.e. user interface) can be broadly classified into two categories: console-based, rich-formatted (in other words WYSWYG).

In a command console type interface, the editing agent presents the transformed document to the user, and provides a command prompt (like MS-DOS prompt) for the user to type in commands. Such a crude interface is very easy to implement, very robust and flexible but has limited user friendliness. Many existing shell scripts such as MSDOS on Windows or other scripting programs on UNIX, can be used to send console commands.

An example of how the syntax of action commands may look is shown below:
delete node 1002 from document “xyz.xml”
update node 1003 to “Hello World” from document “xyz.xml”
copy node 1004 from “abc.xml” before node 1001 from “def.xml”
move node 1004 from “abc.xml” into node 1001 from “def.xml”

Referring now to rich-formatted editing interface, most XML display applications for advance presentation such as markup presentation scripts like XHTML, XSL, SVG, SMIL and MathML are meant to be used for displaying the data and not for user interactive data editing.

In one embodiment of the editing agent, the XML transformed document may contain a new tag element defined to implement user-defined interactivity, such as an <listener> element. The <listener> element may be used to contain and invoke coded routines, such as responding to mouse clicks or other events. The <listener> element may also be attached to or nested inside presentation elements in XHTML, SVG, etc. in order to provide interactive capabilities to otherwise static presentations (W3C's XML Events specification can be referenced to design such event handling elements).

One limitation of the source annotation described so far is that the annotation performed by the source document agent is an ‘have-all’ or ‘have-none’ type, i.e. source annotation is performed on all of source nodes or not performed at all. In a user-rights controlled editing interface, the XML document owner may want to ‘lock’ certain parts of the same document, so that viewers can view those parts of the document without being able to edit them. In this case the XML document administrator author may ‘switch off’ the source annotation functions in the source document agent, or ‘switch off’ the identifier transfer functions in the transformation agent, on the read-only parts of the document. As the resultant transformed document contains no identifiers in the read-only parts, there is no way the editing agent can send effective editing requests to the source document agent on the un-annotated nodes. Only those nodes in the transformed document that has node identifiers support editing actions. Data residing in nodes without identifiers are displayed as ‘read-only’ and cannot be modified since they have no identifiers linking them to the source document. The editing agent may be embedded in a web browser such as Internet Explorer or Netscape. Alternatively, it may be a proprietary user-interactive display programmed by the developer implementing the system. Generally, the display must allow the viewer who has read/write access rights to see and interact with the data in the transformed document underlying the presentation (such as through forms and text boxes in a browser and so on), and to trigger the editing agent to activate the update requests. Any interactive web techniques may be used to facilitate the viewer interaction, for example, Java Applets. The specific presentation format may be defined by a stylesheet, as is common for marked-up language documents.

One variation of the selective node annotation described above is where the selection is done by the transformation/query agent. A fully annotated data source may not have all its identifiers transferred to the transformed version of the data by reason of some criteria in the transformation/query script. Therefore the transformed document has parts which are read only when displayed in a user interface, or by the editing agent.

Three pieces of information that have to be supplied by the editing agent/GUI to the source document agent in an update command are:
Identifier of the target node, i.e. the innermost unique source node identifier in the parent or ancestor nodes. This is the node targeted for the update.
Update action or command
Parameter values that are necessary for the update. If the event is a mouse click, the parameters might be the x, y coordinates relative to the visual display, the number of clicks, the button clicked (left, middle, right). If it is a key event, the parameters might be the key code, repeat count, etc.

### Persistent State During Editing

The editing agent may be programmed to maintain editing states after transformation. For example, after the source document has been edited and the data is updated and displayed to the user, the focus of the display is returned to the very node/data that had the focus before the updating command issued. In other words, the editing agent has state persistency. The editing agent achieves this by recording the identifiers of the nodes and their display states, such as ‘selected’ or ‘focused’. Therefore, no matter how the nodes in the result document are updated, rearranged, or restructured, the editing agent maintain state persistency in the display. For example, re-focusing the screen cursor onto the node which last had the focus, or re-positioning a scrollbar of which position is defined by a node as before an updating action and re-transformation (provided that is it has not been deleted). The persistent state information can be sent back to the XML document agent at the end of the editing session and retrieve at the beginning of the next editing session or, alternatively, it can be retained in the editing agent.

An example of serialisation of state using identifiers is shown in the following using mock syntax, with reference to the XML document further below:

### Serialisation Code:

node 1:1001: isSelected,
node 1:1003: isFocused, caretPostion=2
node 1:1004: scrollbarPosition=1025

### Annotated XML Document:

```
<?UniqueSourceDocumentID www.bn.om/doc123456 as 1 ?>
<?UniqueSourceDocumentID www.amazon.om/doc123456 as 2 ?>
<html>
<body>
<table border=1 cellspacing=0>
  <tr> <td>Title</td> <td>Price from Amazon</td> <td>Price
  from BN</td>
</tr>
  <tr:1:1001>
    <td>TCP/IP Illustrated</td>
    <td>65.95</td>
    <td bgcolor=#ccccff>&1:1003;65.95</td>
  </tr>
  <tr:1:1007>
    <td>Data on the Web</td>
    <td>34.95</td>
    <td bgcolor=#ccccff>&1:1009;34.60</td>
  </tr>
</table>
</body>
</html>
```

### Transformation Script Modification

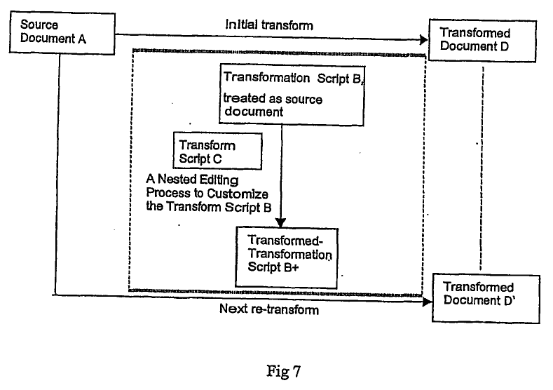

A further variation of the embodiment is in using another transformation script(s) to transform and modify transformation scripts currently used on a source XML document. As XSLT is itself an XML document (and XQuery, while not written in XML syntax, has an equivalent syntax i.e. XQueryX), transformation scripts can, therefore, be transformed in the same manner as source documents. The transformation scripts may even be modified ‘on the fly’, i.e. during an editing session on the source documents. This is possible because this invention does not require the transformation scripts to remain the same during the editing process. FIG. 7 illustrates the concept.

Referring to FIG. 7, source document A is transformed by transform script B into the resultant transformed document D. If the viewer prefers that transformation script B is modified to have different selection criteria, he may activate transformation script C to transform transformation script B into transformation script B′. In such a case, the transformation by the modified script B′ of document A will produce transformed document D′.

### Some Other Variations

Another embodiment of the invention is one which generates source node identifiers that are persistent and unique for only one editing session. Instead of being made up of Originator ID+Document ID+Node ID, the identifier is made up of only Document ID+NodeID. The Originator ID is dropped.

```
<?UniqueSourceDocumentID “c:\doc123.xml” as 1 ?>
<?UniqueSourceDocumentID “c:\doc234.xml” as 2 ?>
<?UniqueSourceNodeMapping 1=1:11001 3=2:11002 4=1:11005 ?>
<div attr =“...”>
    <img/>
    ....
</div>
```

In this case, the source node identifiers are only intended to be used for one editing session and are discarded when the editing session is over. As a result, the source documents can be ported to and from different computers without any restriction, as they do not use system names or addresses as part of their IDs. This can be considered as a scaled-down embodiment of the invention. The advantage of this scaled down embodiment is that the identifiers are simpler to generate and maintain during an editing session.

Although the examples given are addressed in particular to XML documents, these are not restricted in application to only XML documents and can be used on any type of well-defined hierarchical node-based data structure, or marked-up language documents. Furthermore, many non-XML data sources, like HTML, RTF documents can be firstly mapped into an XML equivalent format before editing and then converted back to its original format after editing. The method can also be applied to many other data sources like file system, directory system, Windows registry, relational and object database.

Although this description uses XSLT and XQuery as examples of transformation/query scripts, it is not the intention of the inventor to restrict the use of the teaching with them. There are many other transformation languages with which the mechanisms described herein can be used.

Furthermore, although the terms ‘transformation’ and ‘query’ are usually strictly used with different meanings, referring to the processes of XSLT and XQuery respectively, it is the intention of this specification that they both interchangeably refer to any processes performed on a node-based data source to obtain a set resultant data derived from the data source.

### APPENDIX

The following example is written based on the use case, “1.1 Use Case “XMP”: Experiences and Examples”, from the specification “XML Query Use Cases” at http://www.w3c.org/TR/xquery-use-cases from W3C. The example is used to illustrate how an XML document is transformed and how the changes made to the transformed document are updated in the source document by the method disclosed in the description of this specification. Two sets of mock XML data below show the prices of some books from two different bookstores, BN and Amazon.

| | | |
|---|---|---|
| Sample 1: | | The www.bn.com data, when annotated with unique node |
| | | identifiers, looks as shown below (the annotation is |
| Sample data of book prices from www.bn.com: | | highlighted in bold): |
| <bib> | | <?UniqueDocumentID www.bn.com/doc123456 ?> |
| <book year=“1994”> | | <bib:1000> |
| <title>TCP/IP Illustrated</title> | | <book:1001 year=“1994”> |
| <publisher>Addison-Wesley</publisher> | | <title>&1002;TCP/IP Illustrated</title> |
| <price>65.95</price> | | <publisher>Addison-Wesley</publisher> |
| </book> | | <price>&1003;65.95</price> |
| | | </book> |
| <book year=“1992”> | | <book:1004 year=“1992”> |
| <title>Advanced Programming in the Unix | | <title>&1005,Advanced Programming in the |
| environment</title> | | Unix environment</title> |
| <publisher>Addison-Wesley</publisher> | [symbol] | <publisher>Addison-Wesley</publisher> |
| <price>65.95</price> | | <price>&1006;65.95</price> |
| </book> | | </book> |
| | | <book:1007 year=“2000”> |
| <book year=“2000”> | | <title>&1008;Data on the Web</title> |
| <title>Data on the Web</title> | | <publisher>Morgan Kaufmann |
| <publisher>Morgan Kaufmann | | Publishers</publisher> |
| Publishers</publisher> | | <price>&1009;39.95</price> |
| <price>39.95</price> | | </book> |
| </book> | | <book:1010 year=“1999”> |
| | | <title>&1011;The Economics of Technology |
| <book year=“1999”> | | and Content for Digital TV</title> |
| <title>The Economics of Technology and Content | | <publisher>Kluwer Academic |
| for Digital TV | | Publishers</publisher> |
| </title> | | <price>&1012;129.95</price> |
| <publisher>Kluwer Academic | | </book> |
| Publishers</publisher> | | </bib> |
| <price>129.95</price> | | |
| </book> | | |
| </bib> | | |

| | | |
|---|---|---|
| Sample 2: | | The www.amazon.com data, when annotated with |
| Sample data of book prices from www.amazon.com | | unique node identifiers, looks as shown below (the |
| | | annotation is highlighted in bold): |
| <reviews> | | <?UniqueDocumentID www.amazon.com/doc123456 ?> |
| <entry> | | <reviews:2000> |
| <title>Data on the Web</title> | | <entry:2001> |
| <price>34.95</price> | [symbol] | <title>&2002;Data on the Web</title> |
| <review> A very good discussion ... </review> | | <price>&2003;34.95</price> |
| </entry> | | <review>A very good discussion ... |
| <entry> | | </review> |
| <title>Advanced Programming in the Unix | | </entry> |
| environment</title> | | <entry:2004> |
| <price>65.95</price> | | <title>&2005;Advanced Programming in the |
| <review> A clear and detailed discussion of | | Unix environment</title> |
| UNIX programming. </review> | | <price>&2006;65.95</price> |
| </entry> | | <review>A clear and detailed discussion |
| <entry> | | of UNIX programming.</review> |
| <title>TCP/IP Illustrated</title> | | </entry> |
| <price>65.95</price> | | <entry:2007> |
| <review> One of the best books on TCP/IP. | | <title>&2008;TCP/IP Illustrated</title> |
| </review> | | <price>&2009;65.95</price> |
| </entry> | | |
| </reviews> | | <review>One of the best books on |
| | | TCP/IP.</review> |
| | | </entry> |
| | | </reviews> |

Sample Transformation and Query with Auto Source Annotation

The following are examples of XSLT and XQuery scripts that generate a combined transformed document from the earlier two XML book price documents. After a transformation by either of the scripts, the prices of books from bn.com and amazon.com are selected from the XML documents. The result is formatted in HTML, displaying the titles and prices of books from the two bookstores.

The query expressions/actions which, is executed to create the transformed document, need to be followed by annotation/identifiers transfers from the source documents to the respective nodes in the transformed document. The parts of the codes in the scripts which trigger a transfer of identifiers are highlighted in bold, for example, $b and $a.

| XQuery transformation script: | XSLT transformation script: |
|---|---|
| | <html> |
| <html> | <body> |
| <body> | <table> |
| <table> | <tr> <td>Title</td> <td>Price from Amazon</td> |
| <tr> <td>Title</td> <td>Price from Amazon</td> | <td>Price from BN</td> </tr> |
| <td>Price from BN</td> </tr> | <for-each |
| { | select=“doc(‘http://www.bn.com/bib.xml’)//book”> |
| for $b in doc(“http://www.bn.com/bib.xml”)//book, | <var name=“b” select=“.”/> |
| $a in | <for-each |
| doc(“http://www.amazon.com/reviews.xml”)//entry | select=“doc(‘http://www.amazon.com/reviews.xml’)//entry |
| where $b/title = $a/title | [$b/title = title]”> |
| return | <tr> |
| <tr> | <td> <val-of select=“$b/title”/> </td> |
| <td>{ $b/title }</td> | <td> <val-of select=“price/text( )”/> |
| <td>{ $a/price/text( ) }</td> | </td> |
| <td>{ $b/price/text( ) }</td> | <td> <val-of select=“$b/price/text( )”/> |
| </tr> | </td> |
| } | </tr> |
| </table> | </for-each> |
| </body> | </for-each> |
| </html> | </table> |
| | </body> |
| | </html> |
| When either one of the XSLT and XQuery scripts is run on the | If source annotation has been carried out on the XML |
| un-annotated XML documents of Sample 1 and Sample 2 to | documents before transformation, the transformed document |
| show the book prices of both XML documents should | will inherit the node IDs. The first two tags show the source of |
| generate the HTML document as follows: | each child node as coming from either bn.com or amazon.com. |
| <html> | <?UniqueSourceDocumentID www.bn.om/doc123456 as 1 ?> |
| <body> | <?UniqueSourceDocumentID www.amazon.om/doc123456 as 2 |
| <table border=1 cellspacing=0> | ?> |
| <tr> <td>Title</td> <td>Price from Amazon</td> | <html> |
| <td>Price from BN</td> </tr> | <body> |
| <tr> | <table border=1 cellspacing=0> |
| <td>TCP/IP Illustrated</td> | <tr> <td>Title</td> <td>Price from Amazon</td> |
| <td>65.95</td> | <td>Price from BN</td> </tr> |
| <td>65.95</td> | <tr:2:2007> |
| </tr> | <td>&1:1002;TCP/IP Illustrated</td> |
| <tr> | <td>&2:2009;65.95</td> |
| <td>Advanced Programming in the Unix | <td>&1:1003;65.95</td> |
| environment</td> | </tr> |
| <td>65.95</td> | <tr:2:2004> |
| <td>65.95</td> | <td>&1:1005;Advanced Programming in the Unix |
| </tr> | environment</td> |
| <tr> | <td>&2:2006;65.95</td> |
| <td>Data on the Web</td> | <td>&1:1006;65.95</td> |
| <td>34.95</td> | </tr> |
| <td>39.95</td> | <tr:2:2001> |
| </tr> | <td>&1:1008;Data on the Web</td> |
| </table> | <td>&2:2009;34.95</td> |
| </body> | <td>&1:1009;39.95</td> |
| </html> | </tr> |
| | </table> |
| | </body> |
| | </html> |

>To www.bn.com (as the text is bound to 1:1009): update doc123456/1009 to “34.60”

In the above example, the user can update both source documents at the same time, as all the XML source documents are annotated and the transformation carry over all the Node IDs. This type of non-selective annotation method is termed ‘auto source annotation’, as all nodes are automatically annotated regardless of any criterion.

In a more realistic scenario, a manager from BN might want to review the prices of its books in comparison to those of its competitor Amazon. In this case, he is allowed to have read-only rights to the data from Amazon, but is allowed to have read/write rights to the data from BN. The transform or query language therefore needs to be extended to have user selectivity. The following is an example of an extended XSLT or XQuery script with author-specified source annotation, termed ‘author specific source annotation’ in this specification.

In the XQuery script, [$b], which represents data from the bn.com XML document, the brackets indicates to the transformation engine that source node identifiers should be inherited by the corresponding nodes in the transformed document, so that editing by the viewer can take place. The information which is to be extracted from amazon.com is not to be annotated with the identifiers from the source document, and is scripted without a bracket, i.e. $a, so that the transformation engine will not transfer the identifiers.

In the equivalent XSLT script, the line of code which extracts data from the bn.com XML document is indicated with an source-annotate=“yes”, indicating to the transformation engine that source node identifiers should be passed on to the corresponding nodes in the transformed document. The information which is And the resultant HTML page rendered in an HTML browser or editor should look like:

| | Price from | Price from |
|---|---|---|
| Title | Amazon | BN |
| TCP/IP Illustrated | 65.95 | 65.95 |
| Advanced Programming in the Unix | 65.95 | 65.95 |
| environment | | |
| Data on the Web | 34.95 | 39.95 |

By the embodiments disclosed in the description, a user having read/write access to the data can interact with the rendered HTML document through the editing agent and undertake editing actions by, for example, sending a scripted command through a command console, or through an advance user interface. For example, the user might want to delete the second book and lower the price of the last book.

| | Price from | |
|---|---|---|
| Title | Amazon | Price from BN |
| TCP/IP Illustrated | 65.95 | 65.95 |
| Advanced Programming in the Unix | 65.95 | 65.95 |
| environment | | |
| Data on the Web | 34.95 | 39.95 34.60 |

The request sent to the source agents might, for example, be scripted in a syntax like this through a command console such a MSWindows' command prompt:
>To www.amazon.com (as the entire row is bound to 2:2004):
   delete doc123456/2004
      to be extracted from amazon.com is not to be annotated with the identifiers from the source document, and is scripted with source-annotate=“no”.

| | |
|---|---|
| Solution in XQuery (Query expressions that have explicit | Solution in XSLT: |
| author specified source annotation will be displayed in bold in | |
| the browser, and field editable by the viewer will now be | |
| highlighted with a background.): | <html> |
| | <body> |
| <html><body> | <table> |
| <table> | <tr><td>Title</td> <td>Price from |
| <tr> | Amazon</td> <td>Price from BN</td> </tr> |
| <td>Title</td> | <for-each |
| <td>Price from Amazon</td> | select=“doc(‘http://www.bn.com/bib.xml’)//book” |
| <td>Price from BN</td> | source-annotate=“yes”> |
| </tr> | <var name=“b” select=“.”/> |
| { | <for-each |
| for [$b] in | select=“doc (‘http://www.amazon.com/reviews.xml’) |
| doc(“http://www.bn.com/bib.xml”)//book, | //entry[$b/title = title]” |
| $a in | source-annotate=“no”> |
| doc(“http://www.amazon.com/reviews.xml”)//entry | <tr> |
| | <td> <val-of |
| where $b/title = $a/title | select=“$b/title”/> </td> |
| return | <td> <val-of |
| <tr> | select=“price/text( )”/> </td> |
| <td>{ $b/title }</td> | <td bgcolor=#ccccff> |
| <td>{ $a/price/text( ) }</td> | <annotated-val-of select=“$b/price/text( )”/> |
| <td bgcolor=#ccccff >[ | </td> |
| $b/price/text( ) ]</td> | </tr> |
| </tr> | </for-each> |
| } | </for-each> |
| </table> | </table> |
| </body><html> | </body> |
| | </html> |

In the foregoing script examples, the editable fields will have a coloured background in the HTML display: <td bgcolor=#ccccff>

The transformed or query result with source annotation should look that shown below, where only the bn.com data is annotated with Node IDs.

| <?UniqueSourceDocumentID www.bn.om/doc123456 as 1 ?> | |
|---|---|
| <?UniqueSourceDocumentID www.amazon.om/doc123456 as 2 ?> | |
| <html> | |
| <body> | |
| <table border=1 cellspacing=0> | |
| <tr> | |
| <td>Title</td> <td>Price from Amazon</td> <td>Price | |
| from BN</td> | |
| </tr> | |
| <tr:1:1001> | ←(whole row is |
| annotated) | |
| <td>TCP/IP Illustrated</td> | |
| <td>65.95</td> | ←(cell with |
| Amazon data) | |
| <td bgcolor=#ccccff>&1:1003;65.95</td> | ←(cell with BN |
| data) | |
| </tr> | |
| <tr:1:1004> | |
| <td>Advanced Programming in the Unix | |
| environment</td> | |
| <td>65.95</td> | |
| <td bgcolor=#ccccff>&1:1006;65.95</td> | ←(cell with BN |
| data) | |
| </tr> | |
| <tr:1:1007> | |
| <td>Data on the Web</td> | |
| <td>34.95</td> | |
| <td bgcolor=#ccccff>&1:1009;39.95</td> | ←(cell with BN |
| data) | |
| </tr> | |
| </table> | |
| </body> | |
| </html> | |

The result in an HTML browser or editor should look like:

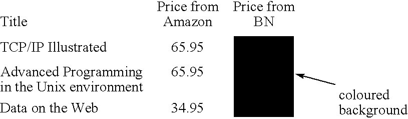

If the bn.com manager wants to carry out the action of changing the bn.com price of the book “Data On The Web”, the requests to the source document agent might have a syntax, without reference to the amazon.com nodes, which looks like:
To www.bn.com:
   delete doc123456/1004
   update doc123456/1009 to “34.60”

In general, auto-source annotation (i.e. annotating all nodes) will work in simple cases, and gives backward compatible support for existing XSLT and XQuery scripts because the extra brackets such as [ ]for selective annotation are not needed. Whereas author-specific source annotation will give the viewer finer control over what is editable in the result document.

As described briefly in the description section of this specification, presentation markup scripts like XHTML can be extended to allow author to further specify more editing functions, for example, by a self-defined <listener> tag, or by other interactive scripts like DHTML etc. As an example, the above XSLT script is shown below, further modified to include a self-defined <listener> tag, by which pre-defined updating commands can be send to the source document agent. This avoids having to use the command console to type in update requests, and thus making updating easier through, for example, by mouse clicks on web browsers or other editing interface.

| | |
|---|---|
| <html><body> | The transformed result document to be displayed for user interaction |
| <table> | would be as follow: |
| <tr> | |
| <td>Title</td> | <?UniqueSourceDocumentID www.bn.om/doc123456 as 1 ?> |
| <td>Price from Amazon</td> | <?UniqueSourceDocumentID www.amazon.om/doc123456 as 2 |
| <td>Price from BN</td> | ?> |
| </tr> | |
| | <html> <body> |
| <for-each | <table border=1 cellspacing=0> |
| select=“doc(‘http://www.bn.com/bib.xml’)//book” source- | <tr> |
| annotate=“yes”> | <td>Title</td> |
| | <td>Price from Amazon</td> |
| <var name=“b” select=“.”/> | <td>Price from BN</td> |
| | </tr> |
| <for-each | <tr:1:1001> |
| select=“doc(‘http://www.amazon.com/reviews.xml’)//entry[ | <listener event=“double-click” action=“delete”/> |
| $b/title = title]” source-annotate=“yes”> | <td>TCP/IP Illustrated</td> |
| | <td>65.95</td> |
| <tr> | <td:1:1003 bgcolor=#ccccff> |
| <listener event=“double-click” action=“delete”/> | <listener event=“key-down” action=“update”/>65.95 |
| <td> <val-of select=“$b/title”/> </td> | </td> |
| <td> <val-of select=“price/text( )”/> </td> | </tr> |
| <td bgcolor=#ccccff source- | <tr:1:1004> <listener event=“double-click” action=“delete”/> |
| annotate=“[$b/price/text( )]”> | <td>Advanced Programming in the Unix environment</td> |
| <listener event=“key-down” | <td>65.95</td> |
| action=“update”/> | <td:1:1006 bgcolor=#ccccff><listener event=“key-down” |
| <val-of select=“$b/price/text( )”/> | |
| </td> | action=“update”/>65.95</td> |
| </tr> | </tr> |
| | <tr:1:1007> |
| </for-each> | <listener event=“double-click” action=“delete”/> |
| </for-each> | <td>Data on the Web</td> |
| </table> | <td>34.95</td> |
| </body> | <td:1:1009 bgcolor=#ccccff> |
| </html> | <listener event=“key-down” action=“update”/>39.95 </td> |
| | </tr> |
| | </table> |
| | </body> <html> |

When the user double click within the table row with the identifier 1004 tagged with the <listener> tag, the editing agent may be programmed to construct the following deletion action script (Analogously, if a console-based interface is used, the same script will be typed in by the viewer to be sent to the source document agent):
To www.bn.com: delete doc123456/1004;

When the user type over the price within the cell with the identifier 1009, the editing agent is able to construct the update request, in response to ‘key-down’ action on the keyboard, as:
To www.bn.com: update doc123456/1009 to “34.60”

| | |
|---|---|
| The source document after the actions are performed may | The re-transformed or re-query document (with the persistent source |
| look like this, note that the row annotated 1004 has been | annotations) should look like that shown below. Note that the value |
| deleted, and the cell annotated 1009 has been updated: | for the book Data on the Web has now been updated. |
| <?UniqueDocumentID www.bn.com/doc123456 ?> | <?UniqueSourceDocumentID www.bn.om/doc123456 as 1 |
| <bib> | ?> |
| <book:1001 year=“1994”> | <?UniqueSourceDocumentID www.amazon.om/doc123456 |
| <title>&1002;TCP/IP Illustrated</title> | as 2 ?> |
| <publisher>Addison-Wesley</publisher> | |
| <price>&1003;65.95</price> | <html> |
| </book> | <body> |
| | <table border=1 cellspacing=0> |
| <book:1007 year=“2000”> | <tr> <td>Title</td> <td>Price from Amazon</td> |
| <title>&1008;Data on the Web</title> | <td>Price from BN</td> </tr> |
| <publisher>Morgan Kaufmann | <tr:1:1001> |
| Publishers</publisher> | <td>TCP/IP Illustrated</td> |
| <price>&1009;34.60</price> | <td>65.95</td> |
| </book> | <td bgcolor=#ccccff>&1:1003;65.95</td> |
| | </tr> |
| <book:1010 year=“1999”> | <tr:1:1007> |
| <title>&1011;The Economics of | <td>Data on the Web</td> |
| Technology and Content for Digital | <td>34.95</td> |
| TV</title> | <td bgcolor=#ccccff>&1:1009;34.60</td> |
| <publisher>Kluwer Academic | </tr> |
| Publishers</publisher> | </table> |
| <price>&1012;129.95</price> | </body> |
| </book> | </html> |
| </bib> | |

The updated result HTML rendered in some HTML browser or editor should look like:

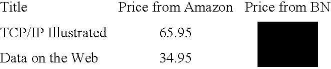

### Inserting New Data

The following sample code shows the capability of copying new data obtained from another source document into a first source document. The transformed document lists all books and their prices from the bn.com source document, and also shows the corresponding Amazon prices. The Amazon list has a price entry missing for the book “The Economics of Technology and Content for Digital TV”.

Assuming now that the viewer is a manager from Amazon.com without write access to bn.com data (not the bn.com manager anymore, as in the example given earlier), the procedure below shows how the above-mentioned source documents from both bn.com and amazon.com are transformed and combined, and how a data insert (or more accurately according to this illustration, a data copy action) may be effected by using the node identifiers. In this example, the bn.com nodes are now not annotated on transformation, while the amazon.com nodes are.

| | | |
|---|---|---|
| Transformation in XQuery with author specified source | | The result document after transformation looks like: |
| annotation (as already described above): | | |
| | | <?UniqueSourceDocumentID www.bn.om/doc123456 as 1 ?> |
| <html> | | <?UniqueSourceDocumentID www.amazon.om/doc123456 as |
| <body> | | 2 ?> |
| <table> | | <html> |
| <tr> | | <body> |
| <td>Title</td> | | <table border=1 cellspacing=0> |
| <td> Price from BN </td> | | <tr> |
| <td> Price from Amazon </td> | | <td>Title</td> |
| </tr> | [symbol] | <td>Price from BN </td> |
| | | <td>Price from Amazon </td> |
| { | | </tr> |
| for $a in doc(“http://www.bn.com/bib.xml”)//book | | |
| return | | <tr> |
| <tr> | | <td>TCP/IP Illustrated</td> |
| <td>{ $a/title }</td> | | <td>65.95</td> |
| <td>{ $a/price/text( ) }</td> | | <td bgcolor=#ccccff > &2:2009;65.95 </td> |
| for $b in doc(“http://www.amazon.com/reviews.xml”)/reviews | | </tr> |
| return | Transformation | |
| <td bgcolor=#ccccff > | | <tr> |
| if (not($b//entry[$c/title = $a/title])) then return | | <td>Advanced Programming in the Unix environment</td> |
| <listener event=“double-click” action=“invoke” | | <td>65.95</td> |
| procedure=”copyPrice” target=“[$b]” | | <td bgcolor=#ccccff > &2:2006;65.95 </td> |
| param=“[$a]”/> | | </tr> |
| for $c in $b//entry where $c/title = $a/title | | <tr> |
| return [$c/price/text( )] | Note the | <td>Data on the Web</td> |
| </td> | procedure is | <td>39.95</td> |
| </tr> | inserted to | <td bgcolor=#ccccff > &2:2003;34.95 </td> |
| } | trigger an | </tr> |
| </table> | insert/copy | <tr> |
| </body> | routine when | <td>The Economics of Technology and Content for Digital |
| </html> | an | TV</td> |
| The event listener is only added when there is no matching | amazon.com | <td>129.95</td> |
| book entry. | cell is double- | |
| | clicked, i.e.: | <td bgcolor=#ccccff> |
| | “copyPrice” | <listener event=“double-click” action=“invoke” |
| | | procedure=”copyPrice” |
| | | param=”1:1010”/> |
| | | </td> |
| | | </tr> |
| | | </table> |
| | | </body> |
| | | </html> |

The rendered result in an HTML browser or editor should look like:

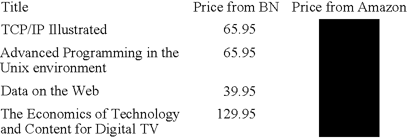

When the amazon.com manager double-clicks on the empty cell, the editing agent is triggered by the code copyPrice( ) in the <listener> tag to send to the source document agent a command to copy the price from the amazon.com to the targeted source node where the copyPrice( ) command is nested in, for example,
To www.amazon.com:
invoke copyPrice(www.bn.com/doc123456/1:1010) on www.amazon.com/doc123456

As shown in the XML document for bn.com above, 1:1010 is the identifier for the parent element and the child nodes:

```
<book:1010 year=“1999”>
    <title>&1011;The Economics of Technology and Content
                for Digital TV
    </title>
    <publisher>Kluwer Academic Publishers</publisher>
    <price>&1012;129.95</price>
</book>
```

The stored procedure or mechanism contained in the ‘copyPrice( )’ command may be scripted for the insertion might look like this:

```
copyPrice($sourceNodeID) {
  insert
  <entry>
      <title>{sourceNodeFromID($sourceNodeID)/title/text
  ( )}
      </title>
      <price>{sourceNodeFromID($sourceNodeID)/price/text
  ( )}
      </price>
      <review>
      <review/>
    </entry>
  into current node; //i.e.node www.amazon.om/doc123456
}
```

The above stored procedure shows an example of how a command text, which is triggered by the double-clicking, inserts the tags such as <entry>, <title>, <price> and <review> to enclose the new data, such that the structure is consistent with the sibling nodes. Again, the actual strategy and implementation the insert mechanism and how it is to work is up to the developer. The purpose of the example is to show that source annotation gives the possibility of very specific position identification.

The updated source document in amazon.com should then look like:

```
<?UniqueDocumentID www.amazon.com/doc123456 ?>
<reviews:2000>
    <entry:2001>
          <title>&2002;Data on the Web</title>
          <price>&2003;34.95</price>
          <review>A very good discussion ... </review>
    </entry>
    <entry:2004>
        <title>&2005;Advanced Programming in the Unix
environment
        </title>
        <price>&2006;65.95</price>
        <review>A clear and detailed discussion of UNIX
programming.
        </review>
    </entry>
    <entry:2007>
          <title>&2008;TCP/IP Illustrated</title>
          <price>&2009;65.95</price>
          <review>One of the best books on TCP/IP.</review>
    </entry>
    <entry>
          <title>The Economics of Technology and Content
for Digital TV
        </title>
          <price>129.95</price> //copied from www.bn.com
          <review></review>
    </entry>
</reviews>
```

Note that the updated source document from amazon.com now has a new price “129.95” for the book the Economic of Technology and Content for Digital TV. The new node is not annotated until the node goes through a cycle of transformation.

It can be envisaged by the skilled man that, as mentioned in the description, a reference may be made to the identifiers of the sibling cells to specifying the position in the amazon.com source document into which the new data should be copied.

The examples show how the annotation system allows data manipulation in an XML document, such that command procedures and routines may be designed to work on the documents to the same effect that query languages are being used to modify tables in other types of database.

1. A method of identifying data in a node-based data source comprising the steps of annotating at least one node with a unique identifier.

2. A method according to claim 1 wherein only selected nodes are annotated with unique identifiers.

3. A method as claimed in claim 1 or 2 wherein the unique identifier comprises of system names or addresses.

4. A method as claimed in claim 1 or 2 wherein the unique identifier does not include system names or addresses; whereby the data source is not restricted to reside in any particular system.

5. A method of modifying a node-based data source comprising the steps of:
associating selected nodes in the data source with identifiers;
identifying a node to be modified by reference to its identifier; and
modifying the node data.

6. A method as claimed in claim 5 wherein the node is identified by selecting a corresponding node from a separate transformed version of the source; wherein
the corresponding node in the separate transformed version and the node in the source document have the same identifier.

7. A method as claimed in claim 5 wherein the node is identified by selecting a corresponding node from a separate transformed version of the source; wherein
the corresponding node in the separate transformed version and the node in the source document are mapped to each other by a series of identifiers;
each identifier in the series representing a transformation in a series of multiple-transformation.

8. A method as claimed in claim 7 whereby the series of identifiers provide means for a proxy or firewall interface whereby the nodes in the data source is protected from unauthorised direct access.

9. A method as claimed in claims 6 or 7 wherein the separate transformed version of the data source is displayed in a desired presentation format.

10. A method as claimed in claims 5, 6 or 7 wherein the modification comprises the steps of:
deleting the selected node in the data source.

11. A method as claimed in claims 6 or 7 wherein the modification further comprises the steps of:
inserting a node in the transformed version of the source;
updating the data source by creating a counterpart node corresponding to the inserted node; wherein
the counterpart node is positioned in the data source in dependence upon at least one property of one or more nodes in the transformed version.

12. A method as claimed in claims 5, 6, 7, 8, 9, 10 or 11 wherein the data source is a marked-up language document.

13. A method as claimed in claims 6, 7, 8, 9 or 11 wherein the transformed data source is a marked-up language document.

14. A method as claimed in claim 6 or 7 wherein at least one node in the transformed data source does not have an identifier; whereby
modification cannot be effected on the node without an identifier.

15. A data source structured to operate as a node-based data source wherein at least one node is associated with a unique identifier.

16. A data source as claimed in claim 12 and 15 wherein the data source is an XML document.

17. A data source as claimed in claim 13 and 14 wherein the transformed version of the data source is a marked up language document.

18. A data source as claimed in claim 18 wherein the markup language is XML.

19. A method of annotating a transformed version of a data source comprising the steps of:
copying identifiers in the nodes in a data source to corresponding nodes in the transformed version of the data source.

20. A method as claimed in claim 19 wherein only selected identifiers are transferred to the transformed version of the data source.

21. A method as claimed in claim 20 wherein the selection criteria for the identifiers are in transformation or query scripts from which the transformed version of the data is derived.

22. An identifier which is capable of uniquely identifying a node in the data source and also a corresponding node in a transformed version of the data source; whereby
the node in the data source is mapped to the corresponding node in the transformed version of the data source.

23. An identifier as claimed in claim 22 which is:
unchanged despite modifications to the data source structure or the data source itself; and
unchanged despite modifications to the structure of or the data in the transformed version of the data source itself.

24. An identifier as claimed in claim 22 wherein the identifier further provides a means of serialising a display in the transformed version of the data source; whereby
the display state of the transformed data source before an update action is returned to that same state in the display after an update action and a refresh of the display.

25. An identifier as claimed in claims 22, 23 or 24 comprising:
identifiers derived from user names.

26. An identifier as claimed in claims 22, 23 or 24 comprising:
identifiers derived from system names.

27. An identifier as claimed in claims 22, 23 or 24 comprising:
identifiers derived from system names and identifiers derived from user names.

28. An identifier as claimed in anyone of claims 22 to 27 which is removed from the node it Identified after an update session is over.

29. A data transformation engine comprising:
means of copying identifiers of nodes in the data source and Inserting the identifiers into the nodes of the transformed version of the data source; whereby
the nodes in the transformed version of the data source are mapped to their corresponding nodes in the data source.

30. A thin-client system implementing the methods as claimed in claim 4 or 5, comprising:
a separate server system in which the transformation takes place;
a separate client system being a system for display of the transformed version of the data source.

31. A fat-client system implementing the methods as claimed in claim 4 or 5, comprising:
a separate server system wherein the data source resides;
the separate client system which receives the data from the server system and in which the transformation of the data source takes place.

32. An industrial standard of node-based document modification adopting the methods as claimed in any one of claims 1 to 14, or any one of claims 17 to 21.

33. An industrial standard of identification of nodes in a node-based document adopting the identifiers as claimed in anyone of claims 22 to 28.

34. An industrial standard of node-based data transformation adopting the engine as claimed in claim 29.

35. A method as claimed in any one of claims 1 to 14, or any one of claims 19 to 21 wherein the data source is itself a transformation script.

36. A data source as claimed in any one of claims 15 to 18 wherein the data source is itself a transformation script.

37. An identifier as claimed in any one of claims 22 to 28 wherein the data source is itself a transformation script.

38. An data transformation engine as claimed in claim 29 wherein the data source is itself a transformation script.

39. A thin-client system as claimed in claim 30 wherein the data source is itself a transformation script.

40. A fat-client system as claimed in claim 31 wherein the data source is itself a transformation script.
